(19) United States
(12) Patent Application Publication
(10) Pub. No.: US 2013/0067374 A1
(43) Pub. Date: Mar. 14, 2013

(54) METHOD FOR DIRECTLY MANIPULATING INCOMING INTERACTIONS IN AN INSTANT COMMUNICATION CLIENT APPLICATION

(71) Applicants: Fabrice Dantec, Brest (FR); Yann Guevel, Brest Cedex (FR)

(72) Inventors: Fabrice Dantec, Brest (FR); Yann Guevel, Brest Cedex (FR)

(21) Appl. No.: 13/513,014

(22) PCT Filed: Nov. 26, 2010
(86) PCT No.: PCT/FR10/52540

§ 371 Date: Oct. 19, 2012

(30) Foreign Application Priority Data
Dec. 4, 2009 (FR) 0905894

(51) Int. Cl. G06F 3/048

(52) U.S. Cl. 715/769

(57) ABSTRACT

Method for directly handling a graphical interface component containing at least one piece of information, this method comprising
A step for selecting the graphical interface component;
A step to display a graphical interface comprising at least one graphical element associated with at least one function using the information contained in the graphical interface component;
A step to Drag-and-Drop the graphical interface component over the graphical element;
An action step comprising the execution of the function;
A step to close the graphical interface.

The present invention relates to the usage of instant communication applications.

Instant communication applications, especially Instant Messaging (IM) or Unified Communication (UC) are experiencing dazzling popularity. They have the particular feature that interactions between users are online and in real-time, thereby enabling an active dialogue, unlike other means of communication whose interactions are carried out off-line and with a delay. It should be noted that instant messaging services are sometimes designated by the terms “chat” and “chatting”.

An instant communication application is a computer system that enables the instant exchange of data (text, video, voice, files, emoticons) among several remote terminals (computers, PDAs, mobile telephones, for example) connected to the same network, most commonly the Internet.

Connection to instant communication requires the use of a client application (a program or Web interface) that connects to an instant communication platform server. Users of instant communication applications therefore generally have an account associated with an instant communication program or Web interface such as My Teamwork™ (published by Alcatel-Lucent), My IC™ (published by Alcatel-Lucent, Skype™, Windows Live Messenger™, Microsoft Office Communicator™ Yahoo! Messenger™, ICQ™, Google Talk™, or MSN™ Web messenger.

Most instant communication applications make it possible inform, in real time, a user signed into this application of unified communication events such as
An interaction in progress (voice communication with “contact1” or with the number 01.23.45.67.89 for example); or
A new incoming interaction (an incoming call, the receipt of a message, or the receipt of a file for example)
   through a graphical interface component, designated according to computer terminology by the expression “toast”.

Conventionally, a toast is manifested in the form of a small information window that is typically displayed at the bottom right of the screen of the terminal from which the user is signed into the instant communication application.

There is typically one toast per unified communication event. In particular, a toast comprises several pieces of information, including
Information (an image, shape, text, or colour, for example) reflecting the type of event (an image of a telephone to designate a voice interaction, a bubble to designate a text interaction, or a miniature preview of a file to designate a data transfer for example);
At least one piece of information (user name, last name, first name, email address, telephone number. IP address, or photo for example) about at least one participant in this event; and
Several functions making it possible to decide upon the follow-up for this unified communication event (answer the call, respond by text message, call, transfer the call to <contact>, redirect to my voice mail, redirect to my mobile telephone, redirect to my fixed line telephone, or save under this <path> for example).

These functions, which are proposed simultaneously for a toast, are represented by buttons, potentially in drop-down menus. The number of these functions is continuously increasing, with the goal of making as many functions accessible through the toast as can be supported by an instant communication client application.

However, the choice of a function from the many functions accessible from the toast risks interrupting the user's work, as he or she would certainly be forced, in some cases, to navigate the menus or windows displayed on his or her screen, for example to select a contact to whom an incoming call should be redirected. The result is that the action in progress (drafting an email, reading an article, participating in a simulation, or watching a video) is interrupted and its content is no longer in the foreground, which could annoy the user.

Document US2007/124677 proposes a user oriented interaction interface. A user interface that comprises a list of icons enabling the user to select functions (document publishing, entertainment, communication) rather than tools.

One purpose of this invention is to improve the ergonomics of user interactions with an instant communication client application.

Another purpose of this invention is to propose an intuitive management system for incoming interactions in an instant communication client application.

Another purpose of this invention is to simplify the handling of unified communication events in an instant communication client application.

To that end, the invention discloses, according to a first aspect, a method for directly handling a graphical interface component containing at least one piece of information, this method comprising
A step for selecting the graphical interface component;
A step to display a graphical interface comprising at least one graphical element associated with at least one function using the information contained in the graphical interface component;
A step to Drag-and-Drop the graphical interface component over the graphical element;
A step to initialise the Drag-and-Drop action making it possible to specify the content of the graphical interface as a function of the information contained in the graphical interface component;
An action step comprising the execution of the function;
A step to close the graphical interface.

Advantageously, the graphical interface component corresponds to a unified communication event in an instant communication client application and the graphical interface contains graphical elements associated with the functions supported by the client application.

The invention discloses, according to a second aspect, an instant communication client application enabling the direct handling of a unified communication event indicated by a graphical interface component, this application comprising
A timer making it possible to initialise direct handling; and
A graphical interface comprising at least one graphical element to call at least one function supported by the client application and using at least one piece of information contained in the graphical interface component.

Advantageously, this direct handling comprises Dragging and Dropping the graphical interface component onto a target graphical element in the graphical interface.

According to a third aspect, the invention proposes a computer program product implemented on a memory medium, which may be implemented within an information processing unit, and comprises instructions for incrementing the method summarized above.

Other characteristics and advantages of the invention will become more clearly and completely apparent upon reading the description below of preferred embodiments, which is done with reference to the attached drawings in which:

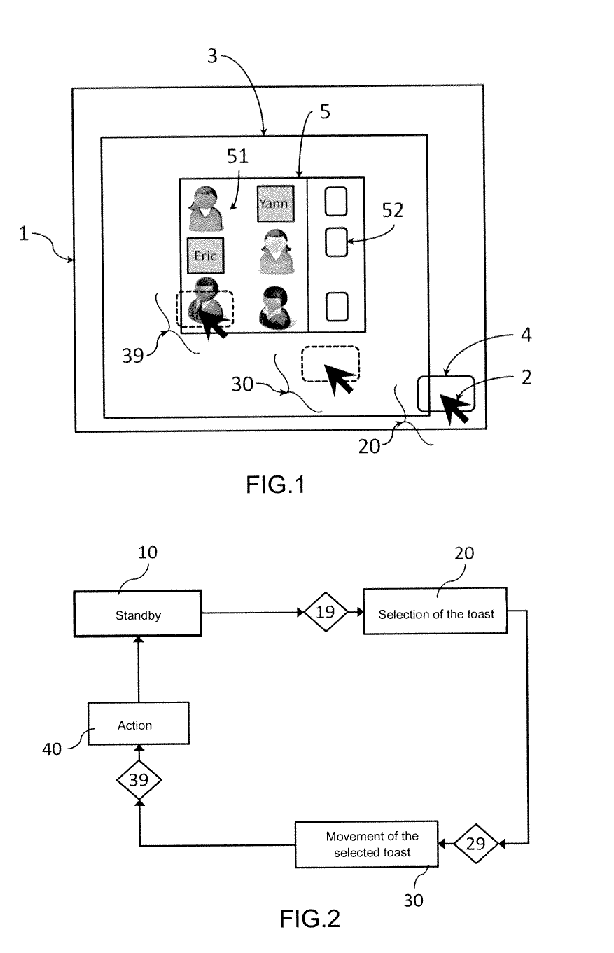

FIG. 1 graphically depicts direct handling of a toast; and

FIG. 2 graphically depicts the steps in an embodiment of direct handling of a toast.

In the present description of the method and system for directly handling incoming interactions in an instant communication application, the assumption is made that a user has an account in an instant communication application and to which he or she is signed in via a client application on a user terminal. A computer (portable/desktop), a Smartphone, a PDA, and a mobile telephone are examples of user terminals.

Non-exhaustive examples of instant communication client applications that can be cited include Trillian™, ICQ™, Alcatel-Lucent My Teamwork™, Alcatel-Lucent My Instant Communicator™, Skype™, Windows Live Messenger™, Microsoft Office Communicator™, and Yahoo! Messenger™ instant communication client software.

We now refer to FIGS. 1 and 2.

FIG. 1 depicts
A display screen 1 that is an output peripheral for a user terminal, enabling visual communication with the user;
A pointer 2 controlled by a pointing device not depicted in FIG. 1. A mouse, touchpad, trackball. TrackPoint, graphics tablet, or light pen are examples of control devices for the pointer 2;
A workspace 3 displayed on the display screen 1, comprising, for example, the desktop of the user terminal, the window (the graphical interface) of a Web browser, or more generally a window of a given application (a video player, an HTML document, a Microsoft Word™ document, simulation software, or an email client application for example).

It should be noted that if the display screen 1 is a touch screen, there may not be a pointer 2. In this case, the effect produced by the pointer 2 and the corresponding pointing device may be obtained by the detection and deflection induced by pressure from a finger or stylus on the display screen 1 or on a sensitive surface associated with the latter. In particular, a touch sensitive display screen 1 makes it possible to determine the action point as well as the movement induced on the two dimensions of the display screen 1.

While the user is signed into the instant communication application, without any unified communication event taking place, the unified communication management method is in standby mode (step 10 in FIG. 2).

Upon receiving a new incoming interaction, the instant communication client application displays a toast 4. After the toast 4 appears on the display device 2, the user can click on the toast 4 when he or she wishes with the pointer 2, or equivalently using a stylus or a finger in the case of a touch sensitive display screen 2.

When the toast 4 is clicked,
A timer 19 is set for a predefined duration (one second for example); and
The toast 4 is selected (step 20 in FIG. 2, which is also diagrammed in FIG. 1).

After the expiration of the predefined duration of the timer 19 and/or the movement of the pointer 2 and/or the movement of the deflection point (in the case of a touch screen display 2 or a sensitive surface associated with the latter):
Initialisation 29 of Drag-and-Drop; and
Display, to the user, of a graphical interface 5 on the display screen 2.

The graphical interface 5 displays several active graphical elements 51-52, which is to say graphical elements 51-52 that call functions supported by the client application through which the user is signed into the instant communication application.

The graphical interface 5 offers the user several graphical elements 51-52 whose functions use the information about the unified communication event announced by the toast 4. For example, the graphical interface 5 enables the user
To redirect an incoming or established call to another terminal (mobile telephone or fixed line telephone for example) by dropping the toast 4 on the appropriate graphical element 52 (an icon of a mobile/fixed line telephone for example);
To redirect an incoming or established call to a termination point by dropping the toast 4 on the appropriate graphical element 52 (an icon for a voice mailbox or an icon for a voice mail server for example);
To redirect an incoming or established call to a contact from a list of contacts in the client application by dropping the toast 4 on the appropriate graphical element 51 (an icon that displays the photo, name, user name, and or email address of a contact for example);
To enter the location to save a file received by dropping the toast 4 on the appropriate graphical element 52 (an icon or text to designate the “Desktop”, or the “My Documents” folder, for example);
To answer an incoming call with a text message by dropping the toast 4 on the appropriate graphical element 52 (an icon displaying the image of a bubble for example);
To initiate a voice interaction if the incoming interaction is in text form, by dropping the toast 4 on the appropriate graphical element 52.

The list of functions offered by the graphical interface 5 may also comprise:
Placing the call on hold;
Transferring a call to another call;
Recording a call;
Recording a voice or video message;
Adding a contact to the user's list of contacts;
Scheduling a meeting or a reminder in the user's calendar application;
Scheduling a telephone or video conference with the participants in an interaction;
Sending an email to the participants in an interaction.
   The graphical elements 51-52 comprise, in particular,
A contact from the user's list of contacts in the client application (contact photo or contact user name for example),
A contact proposed using a piece of information contained in the graphical interface component 4 (name, telephone number, or email address for example); or more generally
An icon reflecting an object (a voice mailbox, a voice mail server, a calendar, conference, an email, or a folder for example).
   Initialising 29 the Drag-and-Drop involves:
The selected toast 4 which is the object to be moved (the source for the Drag-and-Drop); and
The graphical interface 5 comprising the graphical elements 51-52 that constitute the potential targets for the selected toast 4.

Alternatively or in combination, depending upon the information about the unified communication event contained in the selected toast 4, the initialisation 29 specifies the content of the graphical interface 5. In particular, the graphical interface 5 only displays the graphical elements 51-52 whose functions use at least one piece of information contained in the selected toast 4. For example, a call transfer function uses an “incoming call” interaction and not a “file receipt” interaction. In other words, the content of the graphical interface 5 is contextual to the unified communication event.

Alternatively, the initialisation 29 deactivates the graphical elements 51-52 of the graphical interface 5 whose functions do not use the incoming interaction announced by the selected toast 4.

The Drag-and-Drop comprises
Moving (step 20 in FIG. 2, also diagrammed in FIG. 1) the selected toast 4; and
Dropping (step 39 in FIG. 2, also diagrammed in FIG. 1) the toast 4 that has been moved onto a target graphical element 51-52 of the displayed graphical interface 5.

The Drag action results in the movement of the pointer 2 (or deflection point) to the target element of the window while maintaining a given button pushed (left mouse button for example) (or by maintaining pressure with a finger or the stylus).

The movement 20 of the selected toast 4 corresponds to dragging the selected toast 4 by holding down at least one button pressed on the control device for the pointer 2 (typically the left mouse button), or equivalently by maintaining pressure on the display screen 1, or a sensitive surface associated with the latter, using a finger or a stylus. Releasing over a target graphical element 51-52 corresponds to Dropping 39 the toast 4 that was moved over the graphical element 51-52.

The user drags (step 30) the selected toast 4 and drops it (step 39) on the desired graphical element 51-52 of the graphical interface 5.

Preferably, dropping 39 the toast 4 on a graphical element 51-52 of the graphical interface 5 produces a visual and/or audible effect.

Depending upon the target graphical element 51-52 of the Drag-and-Drop, an action 40 is carried out when the toast 4 is dropped 39.

The action 40 corresponds to the execution of the function associated with the target graphical element 51-52. This action 40 is, in particular, dependent upon
The content of the toast 4 (the identifier of the intiator of the incoming action, the type of unified communication event: an incoming call, receipt of a text message, receipt of a file, or receipt of an email for example); and
The target graphical element 51-52 (the photo of a contact, the icon for a voice mailbox, the icon of a bubble, or the icon for a mobile telephone for example) that calls a predefined function (for example to transfer the call, redirect the call, initiate a voice interaction, initiate a text interaction, or save to this address).

Therefore, dropping a toast 4 for an incoming call on the photo 51, or more generally on a contact identifier, makes it possible to transfer the call to this contact. But dropping a toast 4 announcing an incoming call on the icon 52 of a mobile telephone makes it possible to redirect the call to the mobile telephone number designated by the icon 52.

Once the action 40 is launched,
The graphical interface 5 is closed; and
The toast handling application is placed back on standby (step 10 in FIG. 2), until the appearance of a toast 4 concerning another unified communication event.

Consequently, the user can return to his or her work space 3, without management of the toast 4 becoming intrusive.

Advantageously, the method for managing incoming interactions just described comprises the direct handling (Drag-and-Drop) of toasts 4. This avoids the indirect handling (usage of menus and/or dialogues) of toasts
Which could be less ergonomic; and
Which could interrupt the user's work (by hiding the user's work space 3 for example).

Advantageously, the standby state (step 10 in FIG. 2) enables the transparent deployment of the method for managing incoming interactions.

Advantageously, the Drag-and-Drop action makes it much easier to use the toasts 4.

Advantageously, the method just described makes the receipt of incoming interactions more intuitive. For example, in order for a user to transfer an incoming call or voice conversation in progress, indicated by a toast, to a contact on his or her list, he or she would, intuitively, select the toast, drag it and then drop it onto the contact, instead of going through the intermediate steps consisting of opening a menu to carry out these commands.

Alternatives to Drag-and-Drop, such as “Drag-and-Throw” or “Push-and-Throw” may also be used in the method described above.

It should be noted that the method described above,
Is independent of the operating system (Mac OS X/Carbon, Apple MobileOS, X-Window/GTK+, Microsoft Windows, Windows Mobile, Windows CE, or Android for example) used by the user terminal, as long as the system supports Drag-and-Drop; and
May be incorporated into any instant communication client application.

1. Method for directly handling a graphical interface component (4) containing at least one piece of information, this method comprising
A step for selecting the graphical interface component (4);
A step to display a graphical interface (5) comprising at least one graphical element (51-52) associated with at least one function using the information contained in the graphical interface component (4);
A step to Drag-and-Drop the graphical interface component (4) onto the graphical element (51-52);
A step to initialise the Drag-and-Drop action making it possible to specify the content of the graphical interface as a function of the information contained in the graphical interface component;
An action step (40) comprising the execution of the function;
A step to close the graphical interface (5).

2. A method according to claim 1, wherein the Drag-and-Drop step comprises
A step for moving the graphical interface component (4);
A step to Drag-and-Drop the graphical interface component (4) onto the target graphical element (51-52).

3. Method according to claim 1, wherein the information contained in the graphical interface component (4) relates to a unified communication event.

4. Method according to claim 3, wherein the unified communication event is an incoming interaction in an instant communication client application.

5. Method according to claim 1, wherein, the function using the information contained in the graphical interface component (4) is supported by the instant communication client application.

6. Method according to claim 5, wherein the list of functions supported by the client application and using the information contained in the graphical interface component (4) contains at least one function selected from among
The transfer of an incoming or established call to a contact;
The redirection of an incoming call to a voice mailbox;
The redirection of an incoming or established call to a user terminal;
The initiation of a text interaction with a contact;
Placing the call on hold;
Transferring a call to another call;
Recording a call;
Recording a voice or video message;
Adding a contact to the user's list of contacts;
Scheduling a meeting or a reminder in the user's calendar application;
Scheduling a telephone or video conference with the participants in an interaction;
Sending an email to the participants in an interaction.

7. Method according to claim 1, wherein the graphical element (51-52) is a contact from the user's contact list in the client application or a contact proposed using the information contained in the graphical interface component (4).

8. An instant communication client application enabling the direct handling of a unified communication event designated by a graphical interface component (4), this application comprising
A timer making it possible to initiate the direct handling; and
A graphical interface (5) comprising at least one graphical element (51-52) to call at least one function supported by the client application and using at least one piece of information contained in the graphical interface component (4).

9. The client application in claim 8, wherein the direct handling comprises Dragging and Dropping the graphical interface component (4) onto a target graphical element (51-52) in the graphical interface (5).

10. A computer program product implemented on a memory medium, which may be implemented within a computer processing unit, and comprises instructions to implement the method according to claim 1.
